(19) United States
(12) Patent Application Publication
(10) Pub. No.: US 2010/0129144 A1
(43) Pub. Date: May 27, 2010

(54) Snap-Ring System For Connecting Separate Components

(76) Inventor: James Joseph Osborne, Ambler, PA (US)

Correspondence Address: HOWSON & HOWSON LLP, 501 OFFICE CENTER DRIVE, SUITE 210, FORT WASHINGTON, PA, 19034, US

(21) Appl. No.: 12/090,421

(22) PCT Filed: Oct. 30, 2006
(86) PCT No.: PCT/US06/42519

§ 371 Date: Oct. 17, 2008

Related U.S. Application Data
(60) Provisional application No. 60/731,660, filed on Oct. 31, 2005.

(51) Int. Cl. F16B 2/00

(52) U.S. Cl. 403/291

(57) ABSTRACT

A universal snap-engagement system for removably connecting separate components together. The first component has a wall defining a channel with an array of flexible teeth extending from the wall into the channel to at least partially obstruct the channel recess. The teeth are spaced-apart and define open slots there between. A separate second component includes a connection peg that has a front wall and a longitudinally-extending sidewall. The sidewall has a groove this is spaced from the front wall and that extends transversely about the peg. The peg is receivable within the channel such that the flexible teeth are deflected by the peg and return to an original non-defected position when seated within the groove to securely connect the first component to the second component. As an alternative, the teeth can extend from the peg and the groove can be formed in the wall of the first component.

### BACKGROUND OF THE INVENTION

The present invention relates to a system permitting separate products, objects, or implements to be removably connectable such that the products, objects, or implements can be securely connected, separated, and re-connected repeatedly throughout the useful life thereof.

By way of example, U.S. Patent Application No. 2003/0208871 A1 and U.S. Design Pat. No. D499,635 S issued to Osborne disclose a support device having a suction cup that can be mounted on a wall of a shower, bath tub, sink, or the like for holding a cleaning sponge. The sponge can be removed from the support device, used, and re-hung on the support device to dry. In addition, see U.S. Pat. No. 6,053,464 issued to Cardarelli which discloses a suction cup device for use in securing a brush, sponge, cloth, or massaging device to a shower wall and U.S. Pat. No. 5,806,904 issued to Smith which discloses a bottle lifting device.

While the suction cup support devices and shower implements disclosed in the above referenced patents may be satisfactory for their intended purposes, there is a need for a universal snap-engagement system that permits products of all types to be hung, organized, stored, carried, secured and/or displayed in a convenient and novel manner. The system should permit products, objects and implements to be securely connected, separated, and re-connected repeatedly throughout their useful life.

### SUMMARY OF THE INVENTION

The present invention relates to a universal snap-engagement system for removably connecting separate components together. The first component has a wall defining a channel or recess with an array of flexible teeth extending from the wall into the channel or recess to at least partially obstruct the channel or recess. The teeth are spaced-apart and define open slots therebetween. A separate second component is removably connectable to the first component. The second component includes a connection peg that has a front wall and a longitudinally-extending sidewall. The sidewall has a groove that is spaced from the front wall and that extends transversely about the peg. The peg is of a size that is receivable within the channel or recess such that the flexible teeth are deflected by the peg and return to an original non-deflected position when seated within the groove to securely connect the first component to the second component.

As an alternative, the arrangement of the array of teeth on the wall of the first component and the groove on the peg of the second component can be reversed. Thus, the teeth can be provided on the sidewall of the peg and project outwardly therefrom, and an inwardly opening groove can be located on the wall of the first component.

### BRIEF DESCRIPTION OF THE DRAWINGS

The features and advantages of the present invention should become apparent from the following description when taken in conjunction with the accompanying drawings, in which:

FIGS. 1A, 1B and 1C are plan, perspective, and side elevational views, respectively, of a snap-ring according to the present invention;

FIGS. 2A-2F are plan views of alternate snap-rings according to the present invention;

FIGS. 3A and 3B are perspective and cross-sectional views, respectively, of a base unit on which a snap ring of FIG. 1A is releasably connected according to the present application;

FIGS. 4A and 4B are perspective and cross-sectional views, respectively, of an alternate base unit according to the present application;

FIGS. 5A and 5B are side elevational and perspective views, respectively, of an alternate base unit according to the present application;

FIGS. 6, 7 and 8 are side elevational and perspective views of additional alternate base units according to the present application;

FIGS. 9A and 9B are plan and perspective views of an intermediate base unit according to the present invention;

FIGS. 10A-11B are plan and perspective views of alternate intermediate base units according to the present invention;

FIGS. 12A and 12B are side elevational and perspective views of an alternate peg of a base unit according to the present invention;

FIG. 13 is a plan view of an alternate snap-ring according to the present invention;

FIGS. 14A-15B are front elevation and perspective views of clamp and hook implements according to the present invention;

FIG. 15 is a perspective view of a squeegee according to the present invention;

FIGS. 16A-16D are front elevational and perspective views of razors according to the present invention and FIG. 16E is a side elevational view of razor and container combination according to the present invention;

FIGS. 17A-17C are front and side elevational and perspective views of a toothbrush according to the present invention and FIG. 17D is a perspective view of toothbrush and container combination according to the present invention;

FIGS. 18A-18F are front, cross-sectional, and perspective views of bars of soap according to the present invention;

FIGS. 19A-19D are front elevational and perspective views of a soap dish and a towel rack according to the present invention;

FIGS. 20A-20F are front, cross-sectional, and perspective views of bottles according to the present invention;

FIGS. 21A-21C are front and side elevational and perspective views of a tube-shaped container according to the present invention;

FIGS. 22A-22D are elevational and perspective views of cleaning pads and brushes according to the present invention;

FIGS. 23A-23D are cross-sectional and front elevational views of a screw driver according to the present invention;

FIGS. 24A-24D are cross-sectional and front elevational views of a container according to the present invention;

FIGS. 25A-25B are cross-sectional and front elevational views of an alternate container supported on a base unit according to the present invention;

FIGS. 26A-26D are front elevational and perspective views of cosmetic compact cases and lip sticks according to the present invention;

FIGS. 27A-27B are front elevational views of a container and brush combination according to the present invention;

FIGS. 28A-28C are front, cross-sectional, and perspective views of a container according to the present invention;

FIGS. 29A-29C are perspective, plan, and side elevational views of a bottle cap according to the present invention;

FIGS. 30A-30C are perspective, plan, and front elevational views of a bottle topper according to the present invention;

FIGS. 31A-31D are elevational, perspective, and cross sectional views of a water bottle and carrier base unit combination according to the present invention;

FIGS. 32A-32B are elevational and perspective views of a kitchen utensil according to the present invention;

FIGS. 33A-33G are elevational and perspective views of flash lights according to the present invention;

FIGS. 34A-34D are plan and perspective views of dust pans and brooms according to the present invention;

FIGS. 35A-35B are elevational and perspective views of a pair of pliers according to the present invention;

FIGS. 36A-36B are elevational and perspective views of a tape measure according to the present invention;

FIGS. 37A-37B are elevational and perspective views of a pair of a shovel according to the present invention;

FIGS. 38A-38B are elevational and perspective views of a rake according to the present invention;

FIGS. 39A-39B are elevational and perspective views of a writing utensil according to the present invention;

FIGS. 40A-40D are elevational and perspective views of clip boards and notepads according to the present invention;

FIG. 41 is a wash cloth, towel, or cleaning rag according to the present invention;

FIGS. 42A-42B are product packaging according to the present invention;

FIGS. 43A-43C are elevational and cross-sectional views of a cell phone according to the present invention;

FIGS. 44A-44B are elevational and perspective views of a carrying case for a cell phone or the like according to the present invention;

FIGS. 45A-45B are elevational and cross-sectional views of a music playing device according to the present invention;

FIGS. 46A-46B are elevational and perspective views of a shower radio and music playing device according to the present invention;

FIGS. 47-49 are a hair dryer, an illuminated snap ring, and a clock, respectively, according to the present invention;

FIGS. 50A-50B are elevational and perspective views of a picture frame according to the present invention;

FIGS. 51A-51C are elevational and perspective views of a watch or jewelry merchandise display according to the present invention;

FIGS. 52A-52B are elevational and perspective views of an air freshener according to the present invention;

FIGS. 53A-53B are elevational and perspective views of a hair brush according to the present invention;

FIG. 54 is an elevational view of a thermometer according to the present invention;

FIGS. 55A-55C are elevational and perspective views of a pill case according to the present invention;

FIGS. 56A-56B are elevational and perspective views of a bucket and shovel according to the present invention;

FIGS. 57A-57B are elevational and perspective views of a toy according to the present invention;

FIG. 58 is a side elevational view of a trailer hitch and attachment according to the present invention;

FIGS. 59A-59E are cross-sectional, side elevational, and front elevational views of an alternate snap ring and base unit combination according to the present invention; and

FIGS. 60A-60B are side and front elevational views of a further alternate embodiment of a base unit according to the present invention.

### DETAILED DESCRIPTION OF THE PRESENT INVENTION

The present invention relates to a system of connecting together two or more objects or the like for any of a variety of purposes including, storing, organizing, carrying, hanging, and displaying. Typically, a first component has a snap-ring element and a separate second component has a connection peg that is cooperatively received within the snap-ring and engaged by the snap-ring to secure the first component to the second component. As an example, the first component may be any type of hand-held implement, object, product, or device, and the second component can be a base unit for holding the first component. This attachment, or docking, of the first component to the second component is a snap-type or friction-type attachment and is not permanent. Rather, the first and second components are such that they can be repeatedly connected, disconnected, and then re-connected throughout the life of the components.

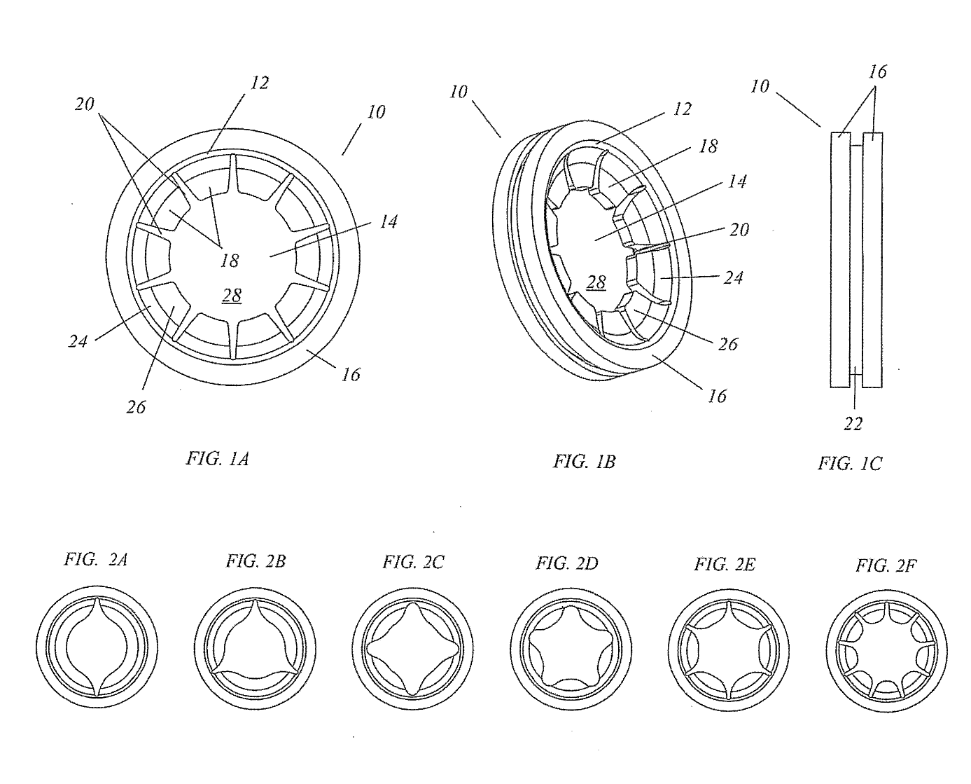

FIGS. 1A-1C illustrate a first embodiment of a snap-ring element 10 according to the present invention. The illustrated snap-ring element 10 has an annular wall 12 that defines a channel, or recess, 14. In the illustrated embodiment, the snap-ring element 10 is provided as a separate pre-manufactured ring 16 that is intended to be affixed to a separately manufactured first component. Alternatively, the annular wall 12 can be molded directly into the body of the first component.

In the illustrated embodiment, the wall 12 is annular and provides a channel or recess 14 that is circular in plan. As an alternative, the channel or recess according to the present invention may be of any shape in plan including rectangular, triangular, oval, multi-sided, or the like.

An array of flexible teeth 18 extends from the annular wall 12 into the channel or recess 14 thereby partially obstructing passage through or into the channel or recess 14. Preferably, the teeth 18 extend radially inward from the annular wall 12 into the channel or recess 14, and the teeth 18 are spaced apart from one another forming radially-extending open slots 20 between each pair of adjacent teeth. The slots 20 provide the teeth 18 with space to flex. The number, shape and form of the teeth 18 can vary. For example, there are ten teeth 18 in the snap-ring 10 illustrated in FIG. 1A, while the number of teeth in FIGS. 2A-2F range from two to nine. Of course, more than ten teeth can be utilized, if desired.

The teeth 18 are resiliently flexible. FIGS. 1A and 1B illustrate the normal positioning of the teeth 18. The teeth 18 can be deflected from this normal position; however, the teeth 18 will resiliently return to the memorized normal position when able. As an example, the teeth can be made of an elastomeric material, a thermoplastic elastomer (TPE), a rubber, a styrenic block copolymer (SBC), polyisoprene, silicon, acrylonitrile-butadiene-styrene (ABS), a polycarbonate, polypropylene, or neoprene. Preferably, the annular wall 12 and ring 16 is made of a relatively rigid material, such as plastic, and a ring 22 of integral teeth 18 is embedded within the plastic ring 16. For instance, see FIG. 1C.

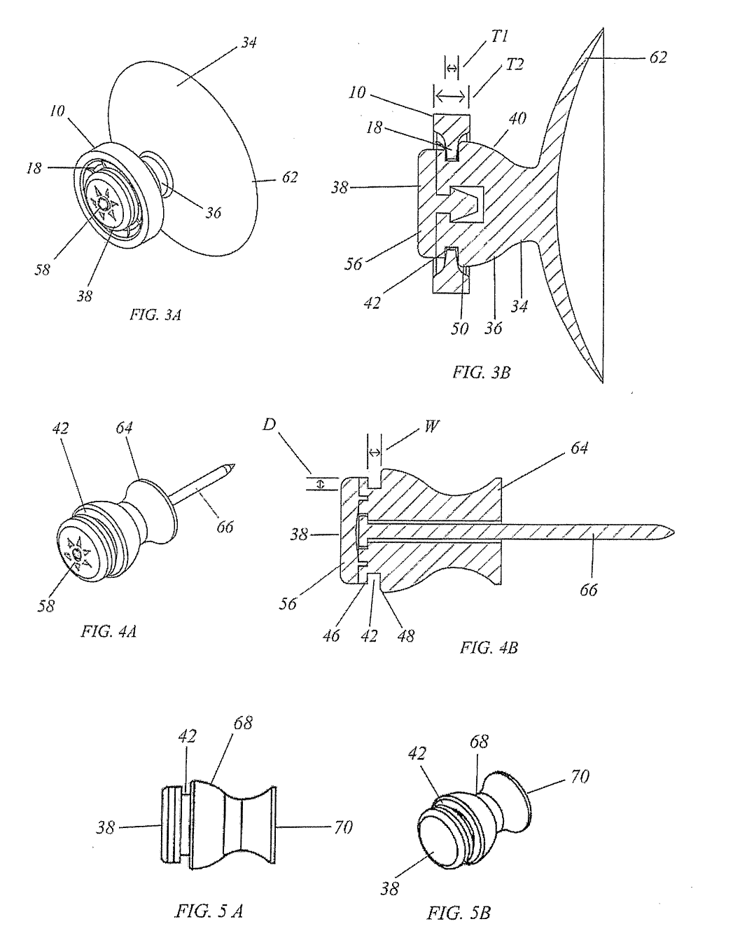

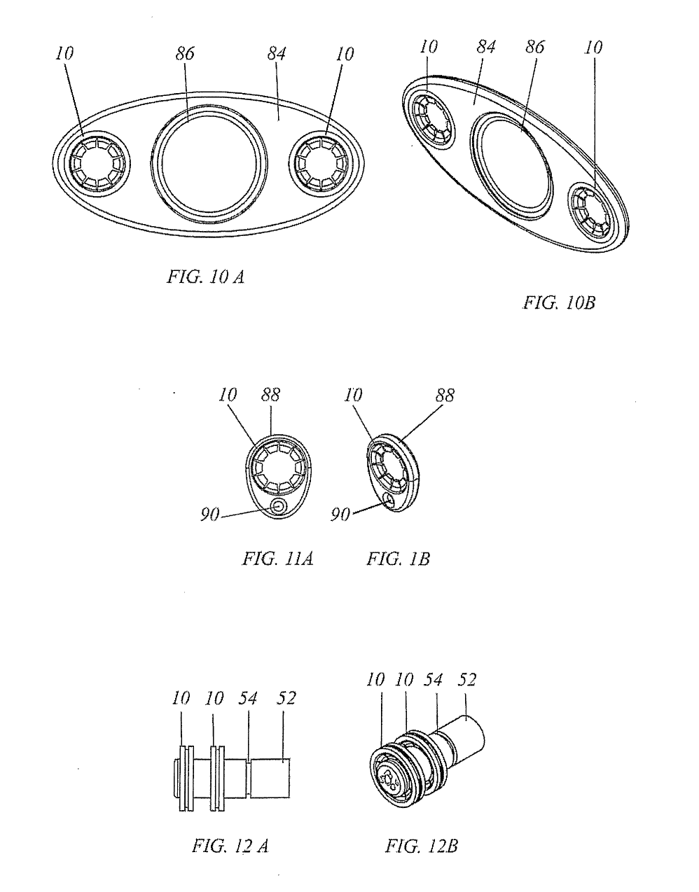

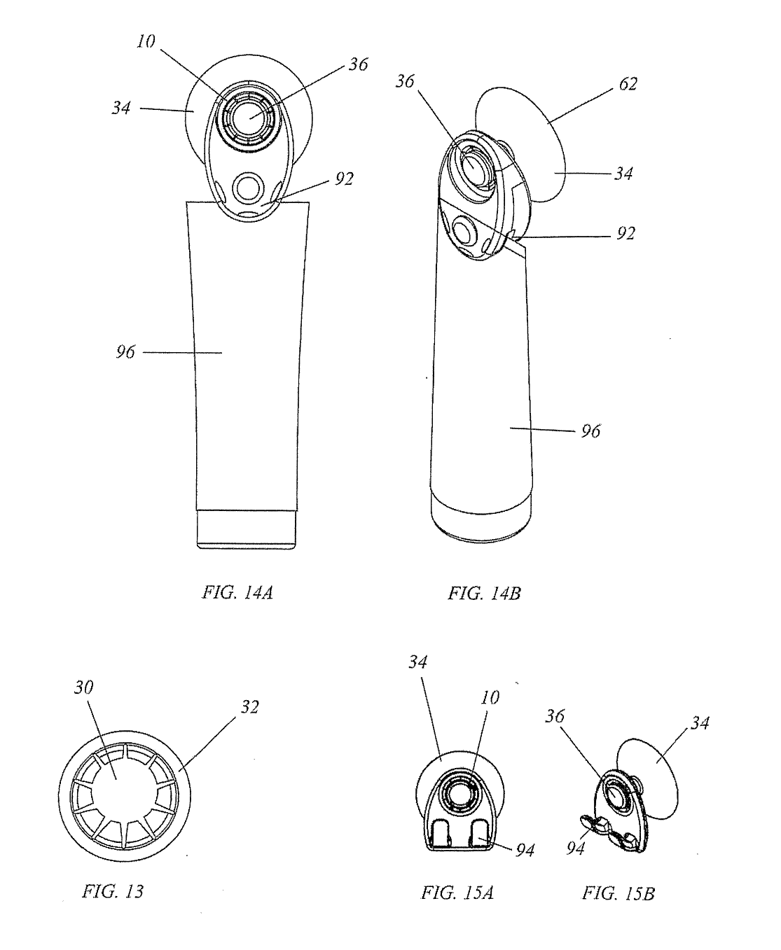

As best shown in FIG. 3B, the teeth 18 have a base section 24 adjacent the annular wall 12 and a free-ended tip section 26 remote from the annular wall 12. Preferably, a thickness “T1” of the base section 24 is greater than the thickness “T2” of the tip section 26. In addition, preferably the tip sections 26 define an unobstructed opening 28 within the channel or recess 14. The unobstructed opening 28 can be centered within the channel or recess 14 (see FIG. 1A). Alternatively, the unobstructed opening can be offset relative to a center of the channel or recess. For example, see unobstructed opening 30 in snap ring 32 illustrated in FIG. 13. The offset can enable a certain area of the snap ring to be strengthened, if needed.

As stated above, the second component is typically a base unit on which the first component can be held, or docked. As an example, FIGS. 3A and 3B disclose one embodiment of a base unit 34. The base unit 34 includes a connection peg 36 that has a front wall 38 and a longitudinally-extending sidewall 40. The sidewall 40 has a groove 42 that is spaced from the front wall 38 and extends transversely, or circumferentially, about the peg 36.

The shape and size of the peg 36, such as its diameter, is provided such that a portion from the front wall 38 to the groove 42 of the peg 36 is receivable within the channel or recess 14 of the snap-ring element 10. The resiliently flexible teeth 18 are deflected by the peg 36 when the peg is inserted into the channel or recess 14. Upon sufficient insertion, the teeth 18 snap into the groove 42 and return to their normal non-deflected position. In this condition, the teeth 18 are seated within the groove 42 and are captured therein. Thus, the first component is removably connected to the second component in a manner providing easy on/off action.

The durometer or measure of hardness of the teeth 18 at least partially determines how much force is required for the on/off action between the first and second components. The teeth 18 can be provided at a particular durometer based on the intended end use of the first and second components. For objects, implements or like first components that are relatively lightweight and/or that will be frequently removed and attached to a base unit, the durometer of the teeth can be, for instance, in a range of about 30 to about 40. For example, if the first component is a tooth brush or squeegee, the teeth may be provided with a durometer of 30 to 40. Alternatively, objects, implements or like first components that are relatively heavy and/or that will be less frequently removed and attached to a base unit, the durometer of the teeth can be closer to 70. For example, if the first component is a soap dish which is removed less frequently only for cleaning purposes or if the first component is a shovel or relatively heavy implement, the teeth can be provided with a durometer of 70.

Preferably, the thickness “T2” of the tip sections 26 of the teeth 18 substantially matches or is only slightly less than a width “W” of the groove 42. Thus, when the tip section 26 is seated within the groove 42, the teeth 18 are snuggly engaged between the opposed walls 46 and 48 of the groove 42. The depth “D” of the groove 42 can be, for instance, about 0.03125 to about 1.0 inch (0.08 to 2.54 cm), or any other size desired.

The peg 36 illustrated in FIG. 3B has an outwardly-extending peripheral ridge 50 adjacent the groove 42 on a side of the groove 42 opposite the front wall 38. The ridge 50 functions as a backstop to prevent the snap ring 10 and teeth 18 from advancing beyond the groove 42 on the peg 36. As an alternative, a peg can be used that has a plurality of grooves. For example, see FIGS. 12A and 12B which illustrate a peg 52 having three longitudinally-spaced grooves 54. This enables multiple snap rings 10, or first components, to be connected to the peg 52 in a back-to-back manner along the length of the peg 52.

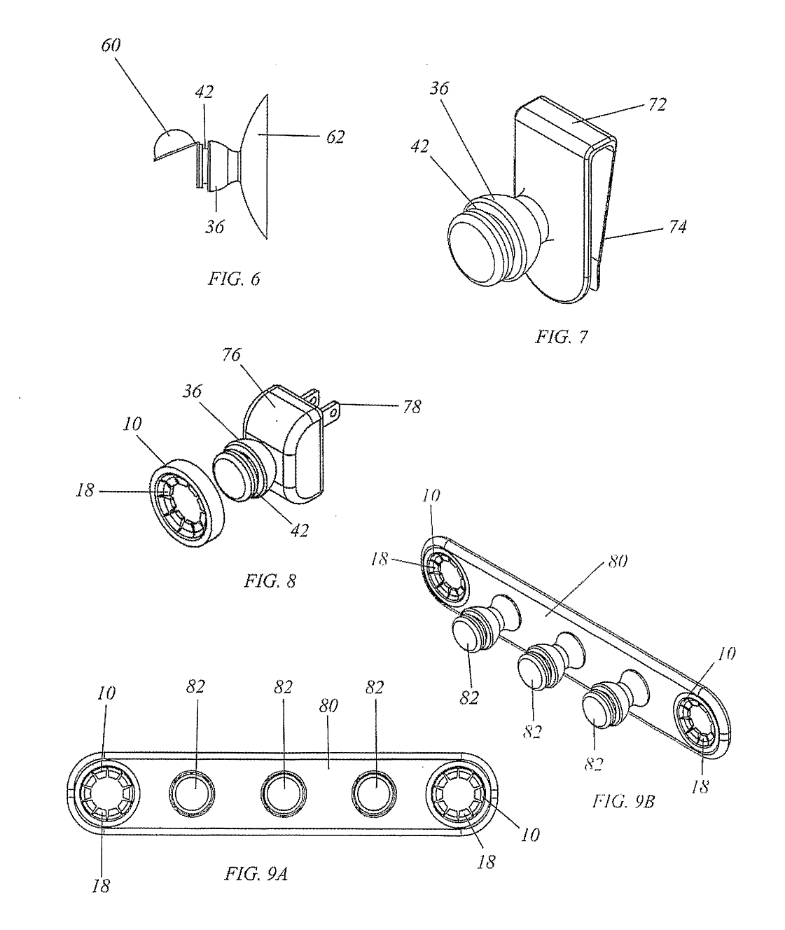

The pegs can carry indicia on their front wall. For example, peg 36 has a cap 56 on which a graphic 58 is displayed. The graphic can be provided by a sticker, printing, relief, or the like. The cap 56 can provide a flat front face or it can be rounded in the form of a dome 60 (See FIG. 6). In addition, the dome 60 can be hinged to the peg providing a storage compartment in the front face of the peg. The storage compartment can house toys, cosmetics, or other consumer products.

If the second component is a base unit, it can have a mounting mechanism for securing the base unit to a desired surface. For example, base unit 34 in FIGS. 3A and 3B have a suction cup 62 for securing base unit 34 to a surface via suction. If a more permanent connection is desired, an adhesive can be applied or sprayed to the back of the suction cup 62 so that the suction cup 62 merely holds the unit in place while the adhesive is permitted to set or cure.

As an alternative mounting mechanism, the base unit 64 illustrated in FIGS. 4A and 4B has a mechanical fastener 66 for use in securing the base unit 64 to a surface. The mechanical fastener can be integrally formed on the base unit 64 or be provided by a headed fastener, such as a nail, screw bolt, drywall fastener or the like. These fasteners can be used in combination with an adhesive, if desired.

Another alternative of a mounting mechanism is illustrated in FIGS. 5A and 5B. In this example, the base unit 68 has a rear wall 70 that can be applied with an adhesive, a piece of double-sided adhesive tape, hook and loop fasteners, a magnet, or the like for securing the rear wall 70 to a surface.

Other examples of mounting mechanisms are disclosed in FIGS. 7 and 8. In FIG. 7, the base unit 72 has a clip or belt clip 74 that can be clipped or clamped onto a desired surface or structure, such as a belt. In FIG. 8, the base unit 76 has an electric plug or prongs 78 for being connected and plugged into an electric wall socket. In this example, the first component can be an air freshener that attaches to base unit 76. When plugged into an electric socket, the combination can cause scents to be released into the air from the air freshener. Alternatively, the base unit 76 can be part of a recharging unit for recharging the batteries within the first component. In this case, the base unit and first component would have engaging electrical contacts.

As thus far described, the system of the present invention includes a first component and a second component; however, the system can also include intermediate components. For example, FIGS. 9A and 9B illustrated a bar-like intermediate member 80 that has multiple pegs 82 and multiple snap rings 10. Accordingly, the intermediate member 80 can be connected to any of the above referenced base units by applying the snap rings 10 onto the pegs of the base units. In addition, first components having snap rings can be applied to the pegs 82 of the intermediate member 80. Thus, the system can include a first component secured to an intermediate component which in turn is secured to a base component. Of course, arrangements having multiple intermediate components can also be utilized.

Another example of an intermediate component is illustrated in FIGS. 10A and 10B. Intermediate member 84 has a pair of smaller snap rings 10 and a larger snap ring 86. Thus, the size of the snap rings and pegs can be altered to provide extra strength as needed.

FIGS. 11A, 11B, 14A, 14B, 15A and 15B illustrate examples of first components having snap rings 10 that connect to a base unit 34 and that, in turn, are used to hang other objects, products or the like therefrom. For example, the first component can be a plate-shaped support 88 having a snap ring 10 and an attachment eyelet 90. Thus, when a base unit having a peg is secured to a desired surface and when the support 88 is connected to the base unit, objects having strings, rope, chains, key chains, hooks or the like can be extended through and attached to eyelet 90 for suspension therefrom. Alternatively, the support can have a clamp 92 or one or more hooks 94. For example, the support can be secured to a base unit and hold a tube 96 or like product in the mouth of the clamp 92 or products can be simply hooked onto one of the hooks 94.

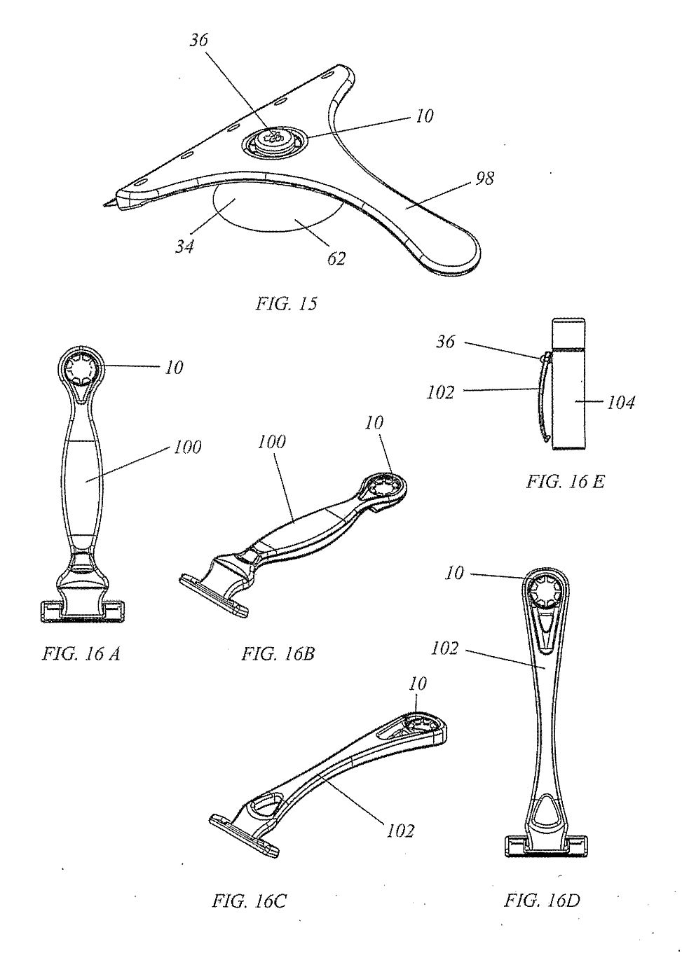

The first components can also be hand held implements that have a handle. For example, a squeegee 98 (see FIG. 15) can have a snap ring 10 enabling the squeegee to be removable connected to a base unit 34. Thus, the base unit 34 can be connected to a wall of a shower, a mirror, a window or like surface and the squeegee 98 can be connected to the base unit 34 for storage purposes until use of the squeegee 98 is desired.

If desired, the snap ring can be located on the handle or a body portion of the first component. The snap ring can be located on the handle, for instance, for relatively lightweight products such as razors and toothbrushes. In contrast, heavier first components, such as hair driers or the like, may have snap rings on a body portion of the product to allow the handle to remain free for being gripped by a user to remove the first component from a base unit. Of course, the snap ring can be located on any part of the first component.

As illustrated in FIGS. 16A-16D, the first component can be a razor 100 or 102 having a snap ring 10 in a handle portion thereof. The razors 100 and 102 can be secured to a base unit on a shower wall, minor or like surface or can be secured to a peg extending from packaging 104, such as a bottle of shaving cream, lotion, or the like. See FIG. 16E. The base units to which the razors 100 and 102 are connected can provide ready storage of the razors, for instance during travel, or can be used in connection with merchandise displays of the razors.

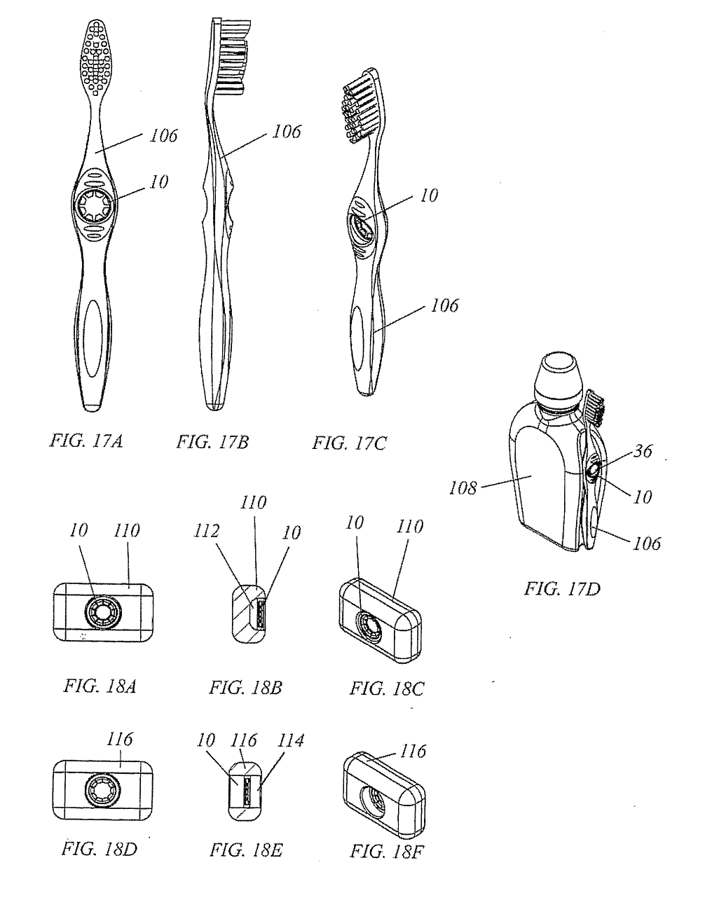

As illustrated in FIGS. 17A-17C, the first component can be a toothbrush 106 having a snap ring 10 in a handle portion thereof. The toothbrush 106 can be hung on a base unit for ready availability and drying and can be secured to a peg extending from packaging 108, such as a bottle of mouth wash, tooth paste, or the like. See FIG. 17D. The snap ring 10 can provide a channel extending entirely through the handle of the toothbrush 106, or it can form a recess opening only on one side of the handle of the toothbrush 106.

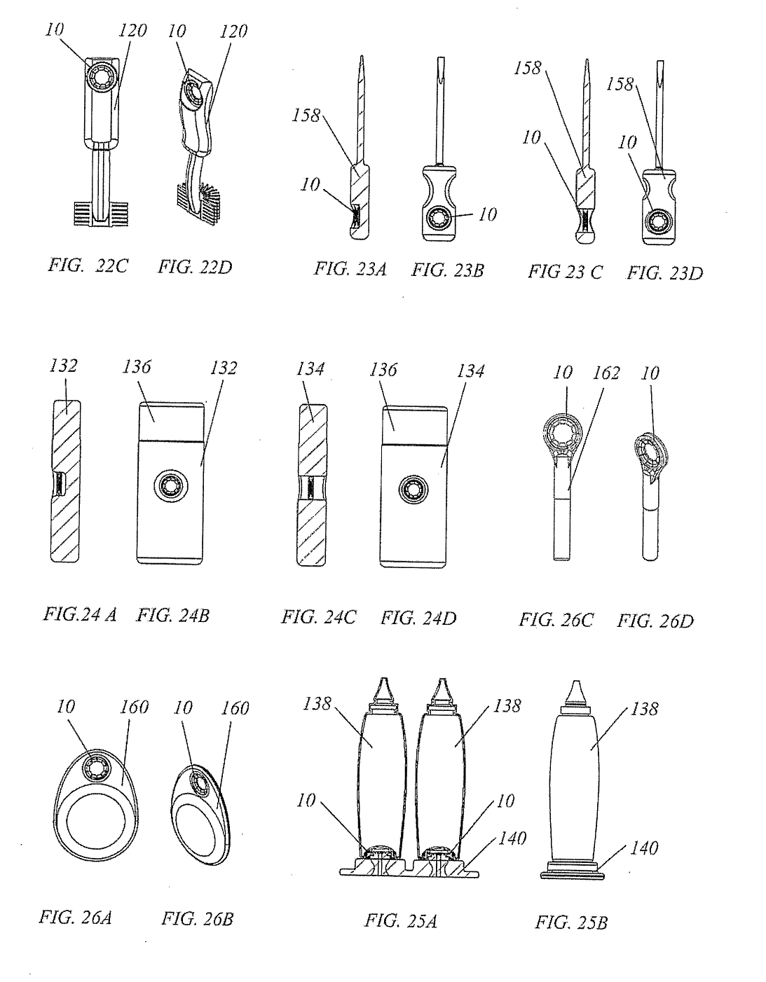

Another bath care product that can have a snap ring 10 is a bar of soap. As shown in FIGS. 18A-18C, the snap ring can be embedded in the soap 110 and be accessible via a recess 112 opening only on one side of the soap 110. Alternatively, a channel 114 can extend entirely through soap 116, and a snap ring 10 can be accessible from both sides of the soap as shown in FIGS. 18D-18F. Also see cleaning pads 118 (FIGS. 22A-22B), cleaning brushes 120 (FIGS. 22C-22D), and towel, rag, wash cloth, automotive shami, or cleaning rag 204 (FIG. 41) that can also have snap rings 10. The pads 118 can be sponges, wash clothes, scrubbing pads, wire pads or the like. The cleaning brushes 120 can be connected to pegs on packaging, bottles of cleaning solutions, buckets, or any other surface.

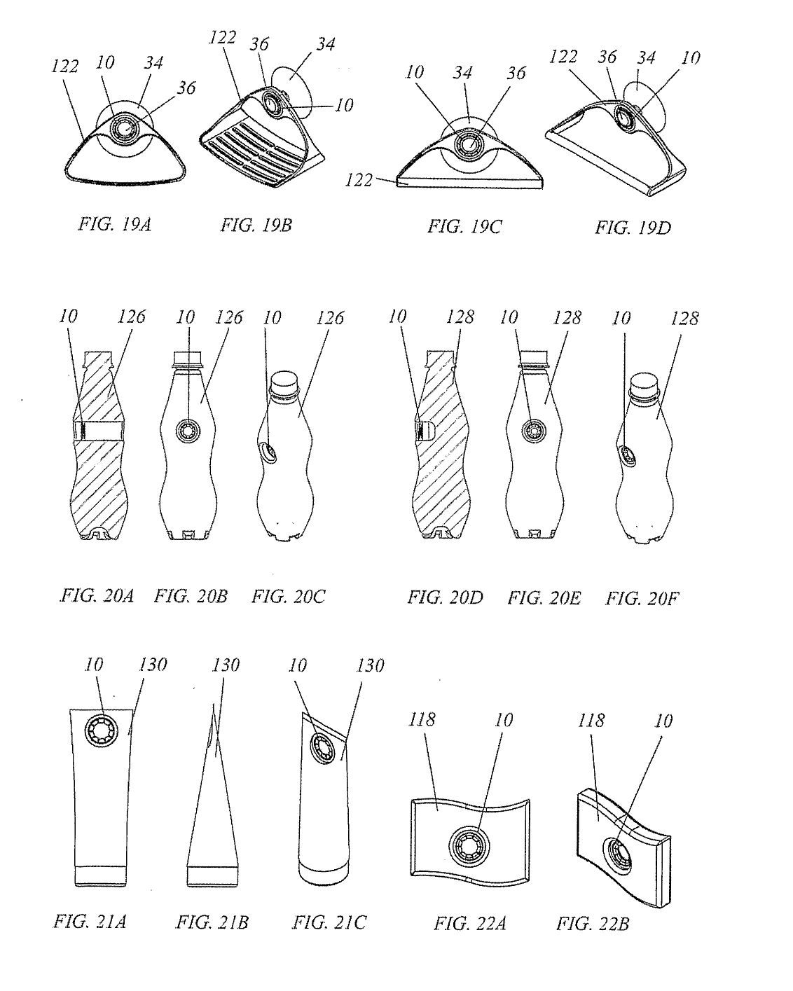

Other bathroom accessories include a soap dish 122 (FIGS. 19A-19B) and a towel rack 124 (FIGS. 19C-19D). The soap dish 122 and towel rack 124 have snap rings 10 that can connect to the base unit 34. These can be readily removed from shower walls, tubs, sinks, and the like to enable ready periodic cleaning of surfaces.

The snap rings 10 can also be utilized on bottles and tubes. For example, see bottles 126 and 128 and tube 130 illustrated in FIGS. 20-20F and 21A-21C. As an example, the bottles 126, 128 can contain beverages or the like, and the tube 130 can contain sun blocks lotions, body wash, shampoo, conditioner, face wash, toothpaste, or the like. Alternative bottle types are illustrated in FIGS. 24A-24D and FIGS. 25A-25B. The bottles 132 and 134 have snap rings 10 in a mid-section area of the bottle enabling the bottle to readily rotate about a peg. For example, bottles 132 and 134 can be spun on the peg to a dispensing position in which the mouth 136 of the bottle is directed downward, or a non-dispensing position in which the mouth 136 of the bottle is disposed in an upward direction. The bottle 138 has a snap ring 10 in a base thereof, and the bottle 138 can be snapped onto a base unit 140 and extend in an upright position. This prevents the bottles from falling off an edge of a shelf or the like. Another type of bottle or container is container 142 illustrated in FIGS. 28A-28C. This container can be a deodorant container, spice container or the like.

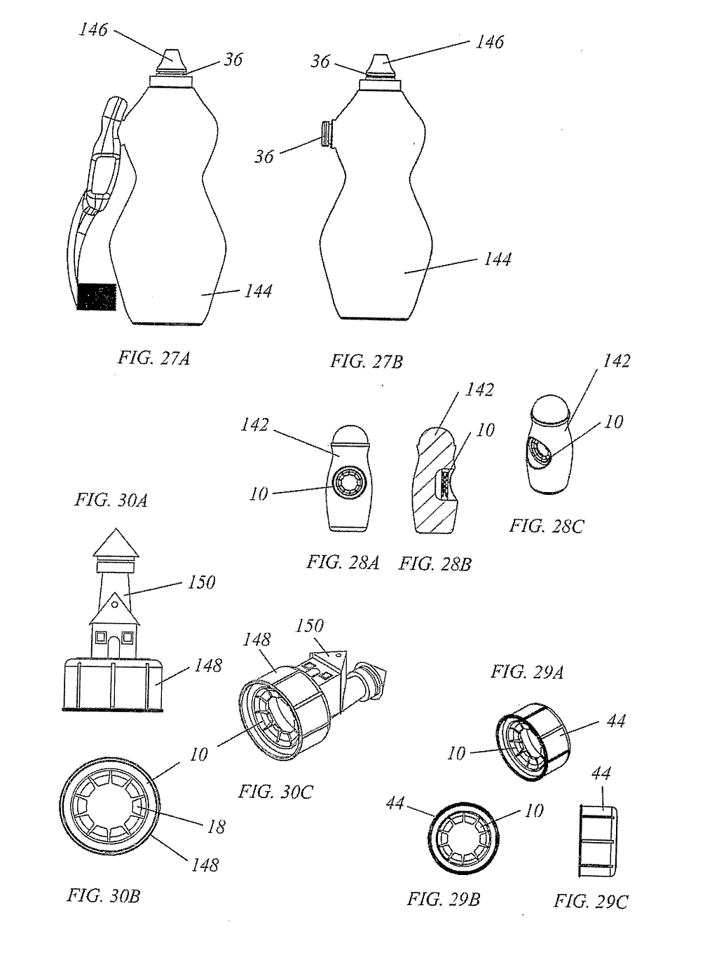

Bottles can also form the second component, or base unit, and have pegs 36 to which snap rings 10 can be removably connected. For example, the bottle 144 has a peg 36 forming a dispensing mouth 146 of the bottle and a peg 36 extending from a side of the bottle 144. See FIG. 27B. As shown in FIG. 27A, this enables a brush or the like to be secured to a side of the bottle 144. In addition, FIGS. 29A-29C disclose bottle caps 44 that can be secured over the dispensing mouth 146 of the bottle 144 to close mouth 146. Bottle caps or toppers 148 (FIGS. 30A-30B) can be also be used. The toppers 148 have decorative features 150 formed thereon.

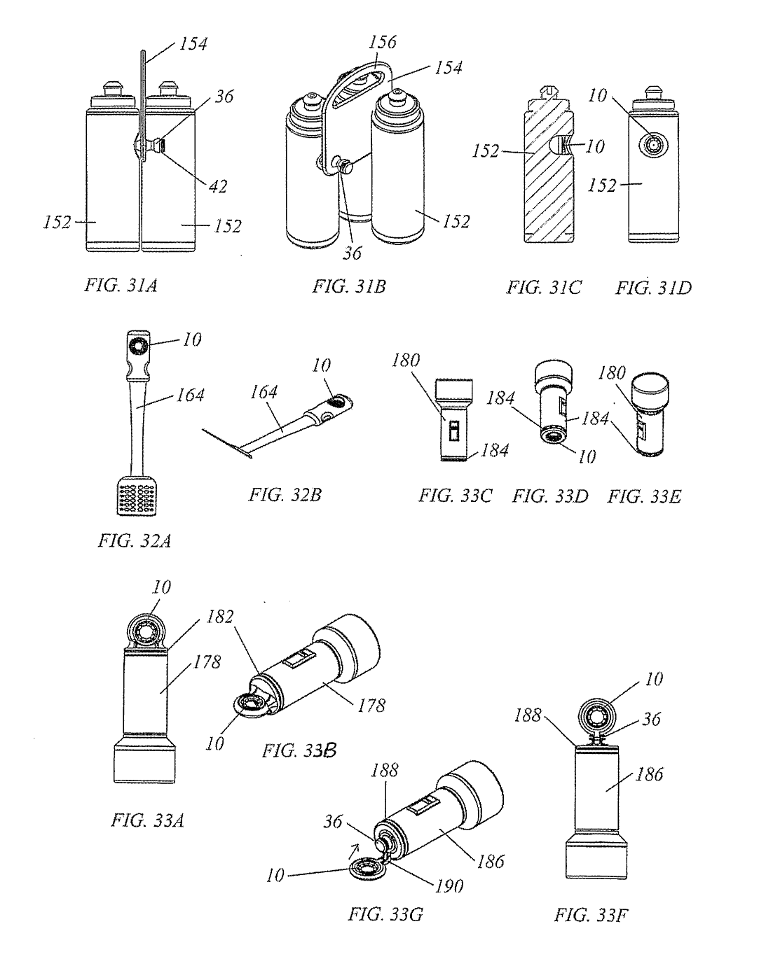

A base unit can also be provided with a handle to enable ready carrying of first components. For example, FIGS. 31A-31C illustrate bottles 152 having snap rings 10 and a base unit 154 having pegs 36 and a handle 156. The bottles 152 can be snapped to the base unit 154 and the handle 156 can be grasped to enable ready lifting and carrying of multiple bottles 152.

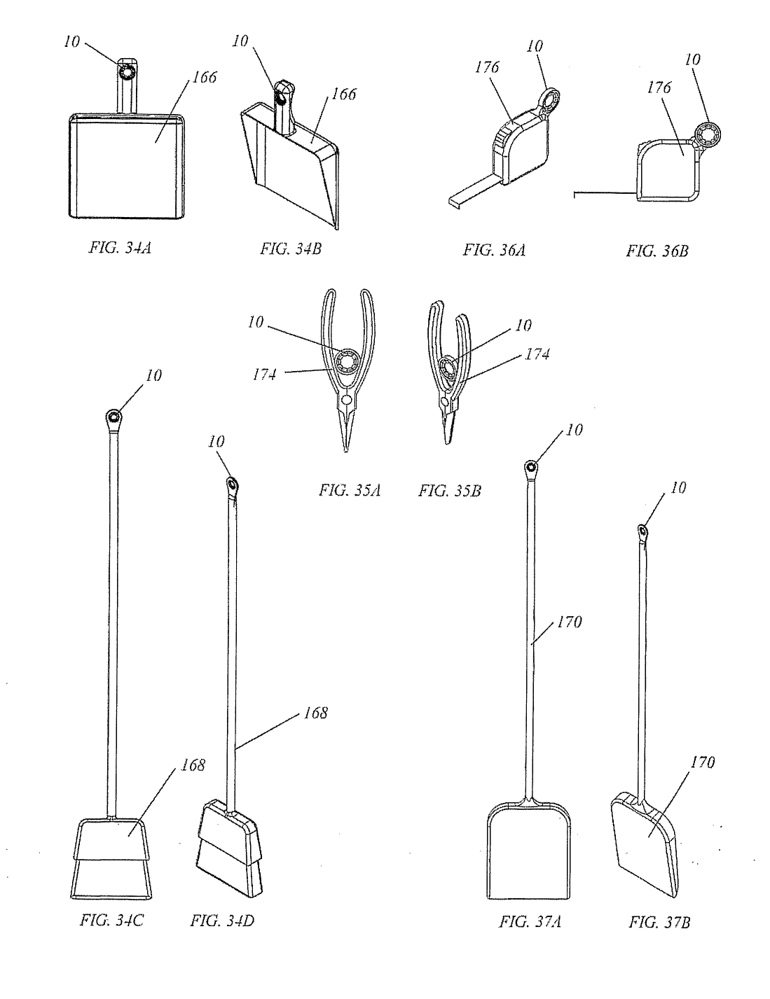

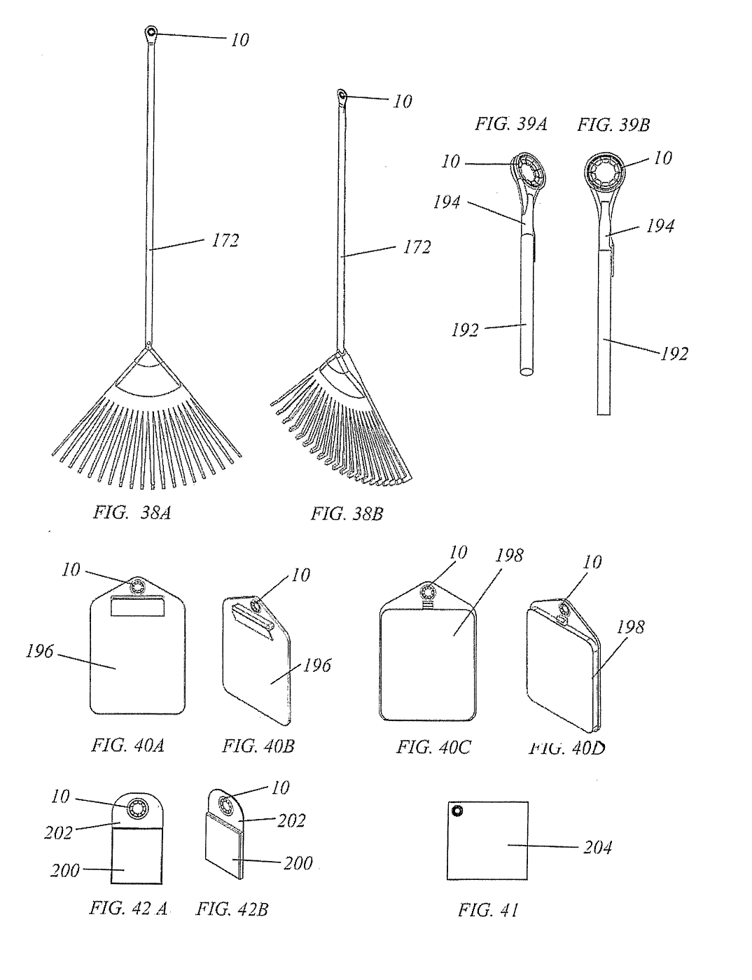

Other products having snap rings 10 can include hand tools, such as screwdrivers 158 (FIGS. 23A-23D), cosmetic products, such as compacts 160 and lip stick 162 (FIGS. 26A-26D), kitchen utensils, such as spatula 164 (FIGS. 32A-32B), and industrial and medical products. Other kitchen utensils can include spoons, forks, tongs, cutters, strainers, peelers, measuring cups and the like. Other tools and utensils also include dust pans 166 and brooms 168 (FIGS. 34A-34D), shovels 170 (FIGS. 37A-37B), rakes 172 (FIGS. 38A-38B), pliers 174 (FIGS. 35A-35B), and tape measures 176 (FIGS. 36A-36B). Other hand tools can include power tools, tool cases, yard tools and the like. Other cosmetic products can include eye liner, lip gloss, mirrors, tweezers, powders, or the like.

The first component can also be a flashlight. In FIGS. 33A-33E, flashlights 178 and 180 have snap rings 10 extending on rear walls thereof. The snap ring 10 of flashlight 178 extends laterally from the rear wall 182, and the snap ring 10 of flash light 180 extends parallel to the rear wall 184. In FIGS. 33F and 33G, the flash light 186 has a snap ring 10 mounted to a rear wall 188 with a hinge 190. Accordingly, the snap ring 10 on flash light 186 can be positioned laterally as shown in the drawings, or be pivoted to extend substantially parallel to the rear wall 188 (see arrow shown in FIG. 33G). The rear wall 188 has a peg 36 to which the snap ring 10 can be attached. For example, the snap ring 10 can be pivoted and locked to the peg 36 so that it is out of the way during use of the flashlight 186.

The first component can also be stationary type supplies or packaging. For example, FIGS. 39A-39B illustrate a writing utensil 192 having a cap 194 with a snap ring 10. The writing utensil can be a pen, pencil, mechanical pencil, marker, highlighter, white-out pen, or the like. FIGS. 40A-40D illustrate a clip board 196 and a notebook 198 having snap rings 10. FIGS. 42A-42B illustrate packaging 200 having a snap ring 10. For instance, the flap 202 of the packaging 200 can be made of cardboard or the like, and the snap ring can enable the packaging 200 to be hung from a merchandise display or the like.

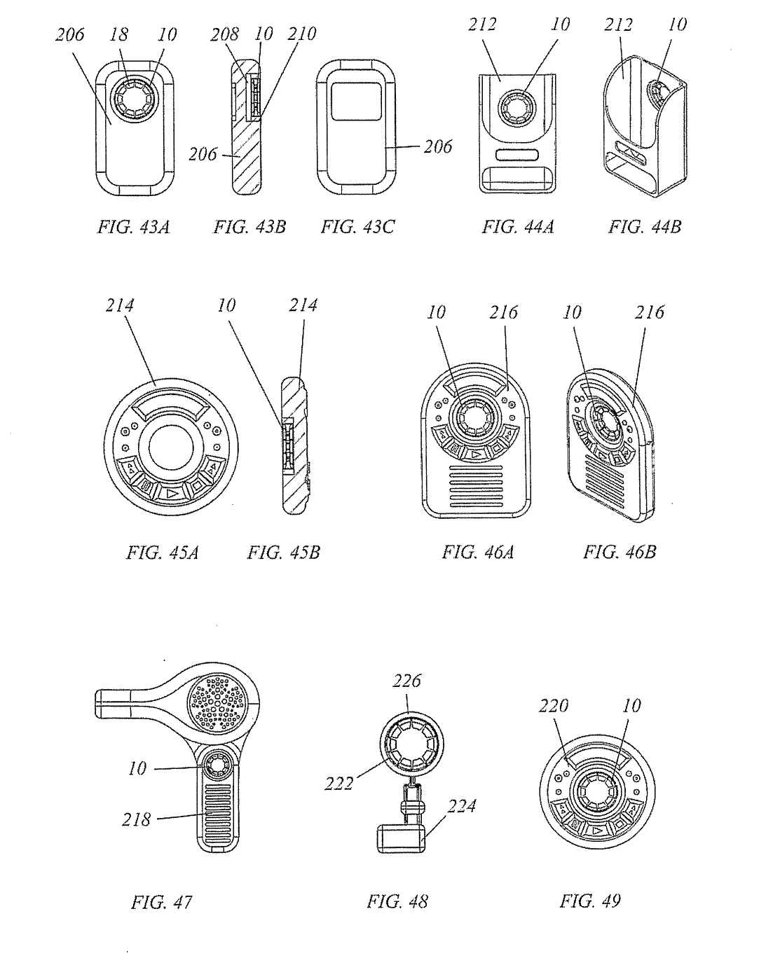

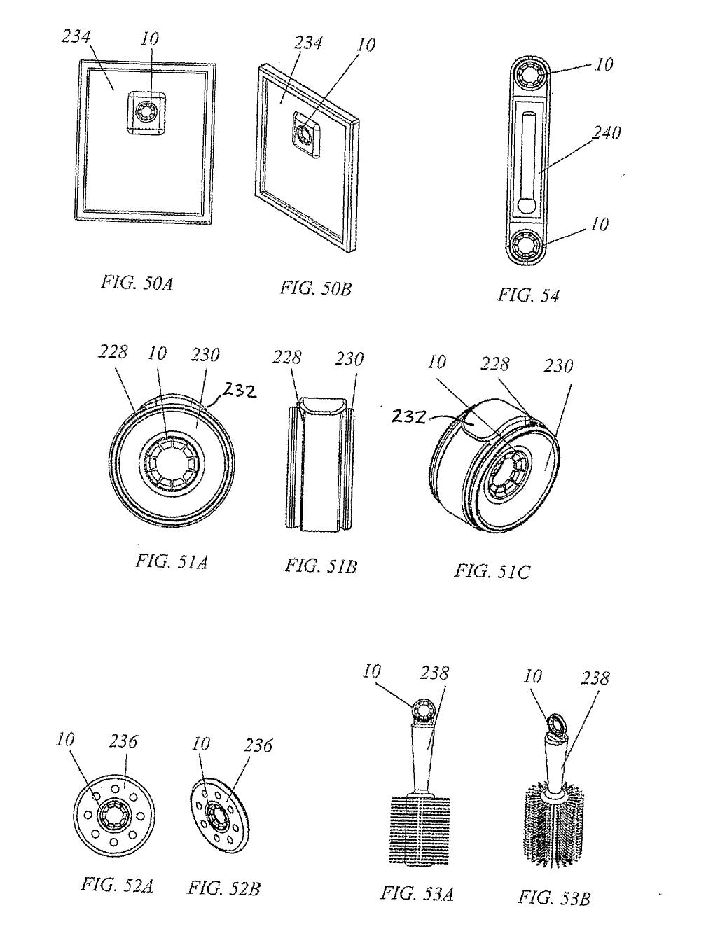

The first component can also be electronic devices of various forms and types. A cell phone 206 is illustrated in FIGS. 43A-43C. A snap ring 10 is located in a recess 208 formed in the back wall 210 of the cell phone 206. Thus, the cell phone 206 can be removably secured to a base unit located in an automobile, on a desk, refrigerator, belt clip, brief case, or the like. Instead of a cell phone, the electronic device can be a BLACK BERRY device, an IPOD device, MP3 player, CD or DVD player, personal organizer, video game playing device, beeper, or the like. As illustrated in FIGS. 44A-44B, a carrying case 212 for an electronic device or the like can have a snap ring 10 for releasable connection to a desired base unit. The electronic devices can also include a music playing device 214 (FIGS. 45A-45B), radio or shower radio 216 (FIGS. 46A-46B), hair dryer 218 (FIG. 47) or clock 220 (FIG. 49).

FIGS. 48 and 51A-51C illustrate first components that can be illuminated. For example, FIG. 48 illustrates a snap ring 222 connected to a battery 224 for illuminating the area 226 extending about the snap ring 222. LEDs, electroluminescent wiring, fiber optics, and various other lighting elements can be arranged about the snap ring. The display device 228 illustrated in FIGS. 51A-51C has a snap ring 10 and a display ring 230 extending thereabout. The display ring 230 can be illuminated and or emit sound and can support a watch 232, jewelry or other accessory for merchandise display or other display purposes.

The first component according to the present invention can also be a picture frame 234 (FIGS. 50A-50B) having a snap ring 10 for use in hanging a picture, an air freshener 236 (FIGS. 52A-52B) having a snap ring 10 for connection to an electrical or non-electrical base unit, a hair brush 238 (FIGS. 53A-53B) having a snap ring 10 in a handle thereof, and a thermometer 240 or like sensor, gauge, or control (FIG. 54) having snap rings. Other hair care products that can have snap rings include combs, picks, scrunches, clips, and rollers.

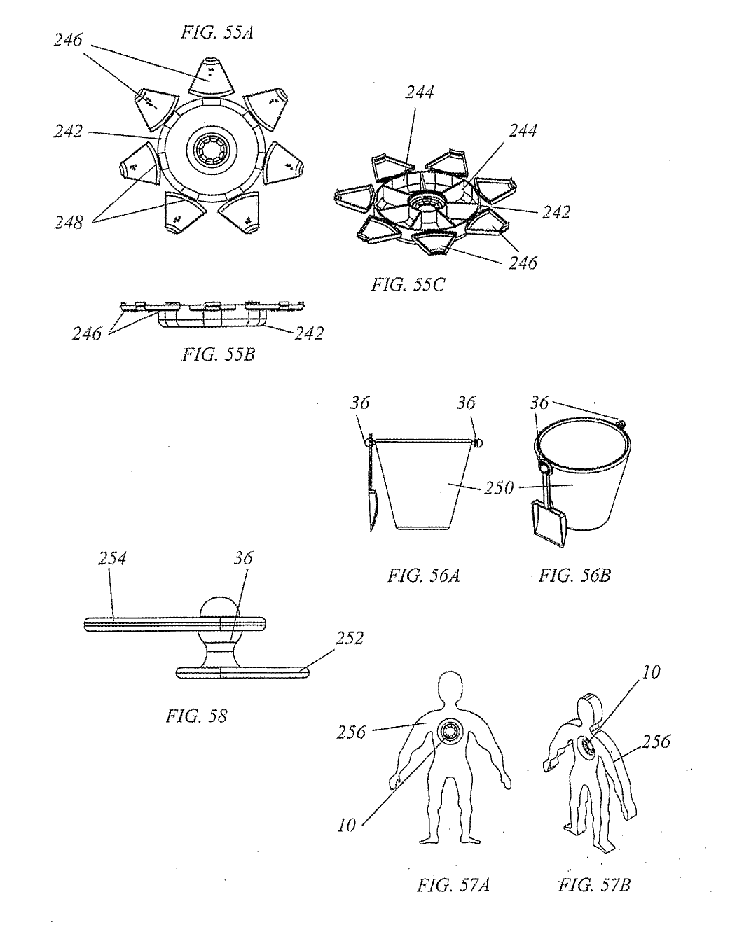

The first component according to the present invention can also be a pill box 242 as illustrated in FIGS. 55A-55C. The pill box has a snap ring 10 in a center thereof with a plurality of pill compartments 244 extending radially therefrom. Each compartment 244 has a lid 246 connected thereto via a live hinge 248. The center location of the snap ring permits the pill box to be rotated about a peg of a base unit. Of course, the present invention can be used in connection with other products having live hinges, such as various products having storage compartment with closable lids.

The base unit of the present invention can be a bucket 250 having a peg 36 to which a shovel, cleaning cloth, brush or like implement is removably connected. The base unit can also be a trailer hitch 252 to which a sign 254 or the like can be connected. Finally, the first component can be a toy of any type. The toy 256 illustrated in FIGS. 57A-57B is a figurine having a snap ring 10; of course, the toy can be anything including letters, numbers, trains, or the like. If the toy is a bath toy, it can be readily hung on a base unit on the wall of a bath or shower to dry.

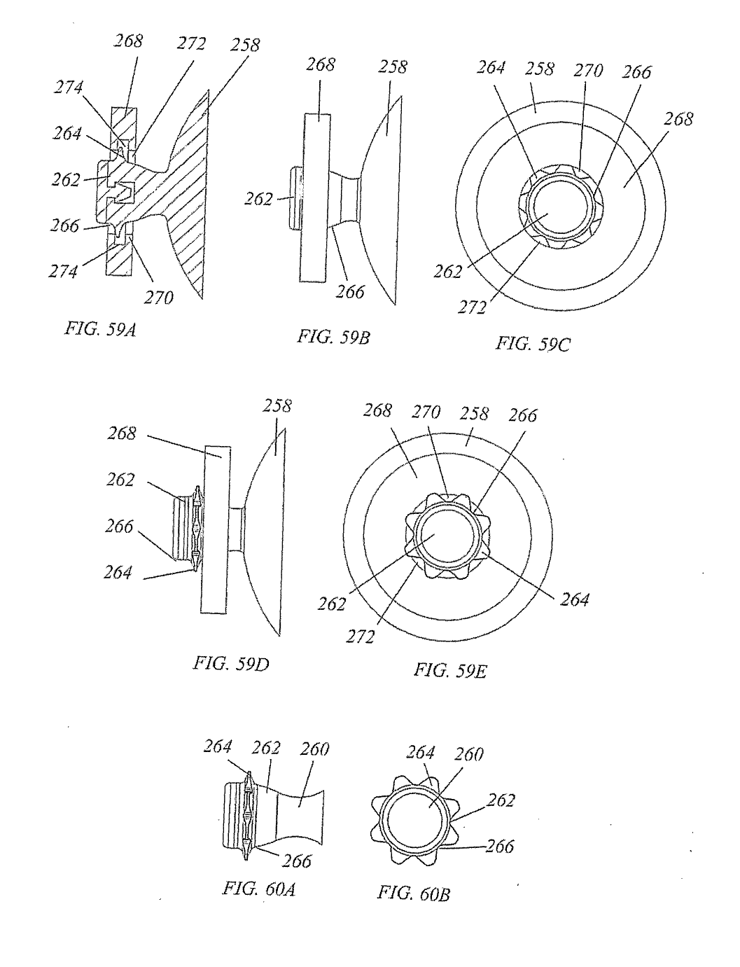

Finally, the arrangement of the teeth can be reversed such that the teeth extend from the peg instead of the snap ring. For example, FIGS. 59A-59E and 60A-60B illustrate base units, 258 and 260, that have pegs 262 with an integral array of resiliently flexible teeth 264 extending outwardly from the sidewall 266 of the peg 262. A snap-ring element 268 is removably connectable to the pegs 262. The snap ring 268 has a wall 270 that defines an open channel or recess 272 and that can have a groove 274 that opens inwardly toward the channel or recess 272. Accordingly, as best illustrated in FIGS. 59A-59C, the snap ring 268 can be pushed onto to the peg 262 such that the teeth 264 are captured within the groove 274. Alternatively, as best illustrated in FIGS. 59D-59E, the snap ring 268 can simply be inserted on the peg 262 beyond the teeth 264 and be captured on the peg 262 due to the presence of the teeth 264.

The above referenced first components and base units can be interchangeable and sold in kits or packs. Thus, any of several selected implements can be secured to the same or different set of base units. The products may be provided in kits with a variety of related products and base units. For instance, a back-to-school pack may include various different back-to-school related implements all connectable to various base units, or a bathroom pack may be sold with various interchangeable bathroom implements, or a travel pack might include various travel implements with base units.

While preferred snap-engagement systems, snap rings, pegs, base units, first components having snap rings, second or base components have pegs, and intermediate components having pegs and snap rings have been described in detail, various modifications, alterations, and changes may be made without departing from the spirit and scope of the system and components according to the present invention as defined in the appended claims.

1-34. (canceled)

35. A universal snap-engagement system for removably connecting separate components together, comprising:
a) a first component comprising:
i) a wall comprising a channel, wherein the wall is annular in regard to the channel; and
ii) an array of flexible teeth extending radially inward from the wall into the channel, wherein the teeth in the array are spaced apart and define open slots therebetween,
b) a separate second component removably connectable to the first component, wherein the second component comprises a connection peg, wherein the connection peg comprises:
i) a front wall;
ii) a groove that is spaced from the front wall and extends circumferentially about the connection peg;
iii) a mounting mechanism; and
iv) a longitudinally-extending sidewall connecting the front wall to the mounting mechanism, wherein the sidewall comprises an outwardly-extending peripheral ridge adjacent the groove on a side of the groove opposite the front wall that functions as a backstop to prevent the teeth from advancing beyond the groove;
wherein the portion of the connection peg from the front wall to the groove is of a size receivable within the channel such that the flexible teeth are deflected by the connection peg, and the teeth are resiliently flexible such that the teeth return to an original non-deflected position within the groove to capture and securely connect the first component to the second component.

36. The universal snap-engagement system according to claim 35 wherein the teeth have a durometer of between about 30 to about 70.

37. The universal snap-engagement system according to claim 35 wherein the front wall of the connection peg comprises a graphic cap, a dome, or an openable storage compartment.

38. The universal snap-engagement system according to claim 35 wherein the mounting mechanism is selected from a suction cup, a clip, a belt clip, an adhesive, double-sided adhesive tape, a hook and loop fastener, a magnet, a mechanical fastener, a headed fastener, a nail, a screw, a bolt, a plug, and an electric plug for an electric socket.

39. The universal snap-engagement system according to claim 35 wherein the teeth are made of a material selected from a thermoplastic elastomer (TPE), a rubber, a styrenic block copolymer (SBC), polyisoprene, silicon, acrylonitrile-butadiene-styrene (ABS), a polycarbonate, polypropylene, and neoprene.

40. The universal snap-engagement system according to claim 35 wherein the array of teeth comprise 2 to 10 identical-sized, uniformly-spaced teeth.

41. The universal snap-engagement system according to claim 35 wherein each of the teeth comprises a base section extending adjacent the wall to a free-ended tip section, and wherein the tip sections of the teeth define an unobstructed opening within the channel.

42. The universal snap-engagement system according to claim 35 wherein the tip section of each of the teeth comprises a thickness (T2) which substantially matches or is slightly less than a width (W) of the groove such that said tip sections are receivable within the groove and are snuggly engaged between opposed walls of the groove.

43. The universal snap-engagement system according to claim 35 wherein the second component is a base unit selected from a container, a bottle, a bucket, a display case, and a trailer hitch.

44. The universal snap-engagement system according to claim 35 wherein the wall of the first component is provided by a substantially-rigid, integrally-molded surface of the first component.

45. The universal snap-engagement system according to claim 35 wherein the first component is a hand-held implement.

46. The universal snap-engagement system according to claim 45 wherein the hand-held implement is a personal care product selected from: tooth brush, hair brush, razor, hair care product, hair dryer, cosmetic product, compact, or lip stick; or a cleaning implement selected from: squeegee, cleaning brush, broom, dust pan, sponge, cleaning pad, soap, wash cloth, towel, cleaning rag, and air freshener; or an electronic device selected from: cell phone, communication device, wireless electronic device, portable music player, radio, shower radio, and clock; or a kitchen utensil selected from: hand tool, screw driver, pliers, tape measure, flash light, yard tool, rake, shovel, thermometer, picture frame, soap dish, towel rack, tube clamp, and hook; or a product packaging selected from: stationary supply, notebook, writing utensil, clip board, and toy; or a container selected from: bottle, bottle cap, bottle topper, tube, pill case, and carrying case.

47. A universal snap-engagement system for removably connecting separate components together, comprising:
a) a first component comprising:
i) a wall comprising a channel; and
ii) an array of flexible teeth extending radially inward from the wall into the channel, wherein the teeth in the array are spaced apart and define open slots therebetween; and
b) a separate second component removably connectable to the first component, wherein the second component comprises a connection peg, wherein the connection peg comprises:
i) a front wall comprising a dome;
ii) a groove that is spaced from the front wall and extends circumferentially about the connection peg;
iii) a mounting mechanism; and
iv) a longitudinally-extending sidewall connecting the front wall to the mounting mechanism, wherein the sidewall comprises an outwardly-extending peripheral ridge adjacent the groove on a side of the groove opposite the front wall that functions as a backstop to prevent the teeth from advancing beyond the groove;
wherein the portion of the connection peg from the front wall to the groove is of a size receivable within the channel such that the flexible teeth are deflected by the connection peg, and the teeth are resiliently flexible such that the teeth return to an original non-deflected position within the groove to capture and securely connect the first component to the second component.

48. The universal snap-engagement system according to claim 47 wherein the wall of the first component is annular in regard to the channel.

49. The universal snap-engagement system according to claim 47 wherein the teeth have a durometer of between about 30 to about 70.

50. The universal snap-engagement system according to claim 47 wherein the mounting mechanism is selected from a suction cup, a clip, a belt clip, an adhesive, double-sided adhesive tape, a hook and loop fastener, a magnet, a mechanical fastener, a headed fastener, a nail, a screw, a bolt, a plug, and an electric plug for an electric socket.

51. The universal snap-engagement system according to claim 47 wherein the teeth are made of a material selected from a thermoplastic elastomer (TPE), a rubber, a styrenic block copolymer (SBC), polyisoprene, silicon, acrylonitrile-butadiene-styrene (ABS), a polycarbonate, polypropylene, and neoprene.

52. The universal snap-engagement system according to claim 47 wherein the array of teeth comprise 2 to 10 identical-sized, uniformly-spaced teeth.

53. The universal snap-engagement system according to claim 47 wherein each of the teeth comprises a base section extending adjacent the wall to a free-ended tip section, and wherein the tip sections of the teeth define an unobstructed opening within the channel.

54. The universal snap-engagement system according to claim 47 wherein the tip section of each of the teeth comprises a thickness (T2) which substantially matches or is slightly less than a width (W) of the groove such that said tip sections are receivable within the groove and are snuggly engaged between opposed walls of the groove.

55. The universal snap-engagement system according to claim 47 wherein the second component is a base unit selected from a container, a bottle, a bucket, a display case, and a trailer hitch.

56. The universal snap-engagement system according to claim 47 wherein the wall of the first component is provided by a substantially-rigid, integrally-molded surface of the first component.

57. The universal snap-engagement system according to claim 47 wherein the first component is a hand-held implement.

58. The universal snap-engagement system according to claim 57 wherein the hand-held implement is a personal care product selected from: tooth brush, hair brush, razor, hair care product, hair dryer, cosmetic product, compact, or lip stick; or a cleaning implement selected from: squeegee, cleaning brush, broom, dust pan, sponge, cleaning pad, soap, wash cloth, towel, cleaning rag, and air freshener; or an electronic device selected from: cell phone, communication device, wireless electronic device, portable music player, radio, shower radio, and clock; or a kitchen utensil selected from: hand tool, screw driver, pliers, tape measure, flash light, yard tool, rake, shovel, thermometer, picture frame, soap dish, towel rack, tube clamp, and hook; or a product packaging selected from: stationary supply, notebook, writing utensil, clip board, and toy; or a container selected from: bottle, bottle cap, bottle topper, tube, pill case, and carrying case.

59. A universal snap-engagement system for removably connecting separate components together, comprising:
a) a first component comprising:
i) a wall comprising a channel; and
ii) an array of flexible teeth extending radially inward from the wall into the channel, wherein the teeth in the array are spaced apart and define open slots therebetween; and
b) a separate second component removably connectable to the first component, wherein the second component comprises a connection peg, wherein the connection peg comprises:
i) a front wall;
ii) a groove that is spaced from the front wall and extends circumferentially about the connection peg;
iii) a mounting mechanism selected from a suction cup, a clip, a belt clip, an adhesive, double-sided adhesive tape, a hook and loop fastener, a magnet, a mechanical fastener, a headed fastener, a nail, a screw, a bolt, a plug, and an electric plug for an electric socket; and
iv) a longitudinally-extending sidewall connecting the front wall to the mounting mechanism, wherein the sidewall comprises an outwardly-extending peripheral ridge adjacent the groove on a side of the groove opposite the front wall that functions as a backstop to prevent the teeth from advancing beyond the groove;
wherein the portion of the connection peg from the front wall to the groove is of a size receivable within the channel such that the flexible teeth are deflected by the connection peg, and the teeth are resiliently flexible such that the teeth return to an original non-deflected position within the groove to capture and securely connect the first component to the second component.

60. The universal snap-engagement system according to claim 59 wherein the wall of the first component is annular in regard to the channel.

61. The universal snap-engagement system according to claim 59 wherein the front wall of the connection peg comprises a graphic cap, a dome, or an openable storage compartment.

62. The universal snap-engagement system according to claim 59 wherein the teeth have a durometer of between about 30 to about 70.

63. The universal snap-engagement system according to claim 59 wherein the teeth are made of a material selected from a thermoplastic elastomer (TPE), a rubber, a styrenic block copolymer (SBC), polyisoprene, silicon, acrylonitrile-butadiene-styrene (ABS), a polycarbonate, polypropylene, and neoprene.

64. The universal snap-engagement system according to claim 59 wherein the array of teeth comprise 2 to 10 identical-sized, uniformly-spaced teeth.

65. The universal snap-engagement system according to claim 59 wherein each of the teeth comprises a base section extending adjacent the wall to a free-ended tip section, and wherein the tip sections of the teeth define an unobstructed opening within the channel.

66. The universal snap-engagement system according to claim 59 wherein the tip section of each of the teeth comprises a thickness (T2) which substantially matches or is slightly less than a width (W) of the groove such that said tip sections are receivable within the groove and are snuggly engaged between opposed walls of the groove.

67. The universal snap-engagement system according to claim 59 wherein the second component is a base unit selected from a container, a bottle, a bucket, a display case, and a trailer hitch.

68. The universal snap-engagement system according to claim 59 wherein the wall of the first component is provided by a substantially-rigid, integrally-molded surface of the first component.

69. The universal snap-engagement system according to claim 59 wherein the first component is a hand-held implement.

70. The universal snap-engagement system according to claim 69 wherein the hand-held implement is a personal care product selected from: tooth brush, hair brush, razor, hair care product, hair dryer, cosmetic product, compact, or lip stick; or a cleaning implement selected from: squeegee, cleaning brush, broom, dust pan, sponge, cleaning pad, soap, wash cloth, towel, cleaning rag, and air freshener; or an electronic device selected from: cell phone, communication device, wireless electronic device, portable music player, radio, shower radio, and clock; or a kitchen utensil selected from: hand tool, screw driver, pliers, tape measure, flash light, yard tool, rake, shovel, thermometer, picture frame, soap dish, towel rack, tube clamp, and hook; or a product packaging selected from: stationary supply, notebook, writing utensil, clip board, and toy; or a container selected from: bottle, bottle cap, bottle topper, tube, pill case, and carrying case.

71. A universal snap-engagement system for removably connecting separate components together, comprising:
a) a first component comprising:
i) a wall comprising a channel, wherein the wall is annular in regard to the channel, and wherein the wall is provided by a substantially-rigid, integrally-molded surface of the first component; and
ii) an array of flexible teeth extending radially inward from the wall into the channel, wherein the teeth in the array are spaced apart and define open slots therebetween, wherein the teeth have a durometer of between about 30 to about 70, wherein the array of teeth comprise 2 to 10 identical-sized, uniformly-spaced teeth, and wherein the teeth are made of a material selected from a thermoplastic elastomer (TPE), a rubber, a styrenic block copolymer (SBC), polyisoprene, silicon, acrylonitrile-butadiene-styrene (ABS), a polycarbonate, polypropylene, and neoprene; and
b) a separate second component removably connectable to the first component, wherein the second component comprises a connection peg, wherein the connection peg comprises:
i) a front wall comprising a graphic cap, a dome, or an openable storage compartment;
ii) a groove that is spaced from the front wall and extends circumferentially about the connection peg;
iii) a mounting mechanism selected from a suction cup, a clip, a belt clip, an adhesive, double-sided adhesive tape, a hook and loop fastener, a magnet, a mechanical fastener, a headed fastener, a nail, a screw, a bolt, a plug, and an electric plug for an electric socket; and
iv) a longitudinally-extending sidewall connecting the front wall to the mounting mechanism, wherein the sidewall comprises an outwardly-extending peripheral ridge adjacent the groove on a side of the groove opposite the front wall that functions as a backstop to prevent the teeth from advancing beyond the groove;
wherein the portion of the connection peg from the front wall to the groove is of a size receivable within the channel such that the flexible teeth are deflected by the connection peg, and the teeth are resiliently flexible such that the teeth return to an original non-deflected position within the groove to capture and securely connect the first component to the second component.

72. The universal snap-engagement system according to claim 71 wherein each of the teeth comprises a base section extending adjacent the wall to a free-ended tip section, wherein the tip sections of the teeth define an unobstructed opening within the channel, and wherein the tip section of each of the teeth comprises a thickness (T2) which substantially matches or is slightly less than a width (W) of the groove such that said tip sections are receivable within the groove and are snuggly engaged between opposed walls of the groove.

73. The universal snap-engagement system according to claim 71 wherein the second component is a base unit selected from a container, a bottle, a bucket, a display case, and a trailer hitch.

74. The universal snap-engagement system according to claim 71 wherein the first component is a hand-held implement.

75. The universal snap-engagement system according to claim 74 wherein the hand-held implement is a personal care product selected from: tooth brush, hair brush, razor, hair care product, hair dryer, cosmetic product, compact, or lip stick; or a cleaning implement selected from: squeegee, cleaning brush, broom, dust pan, sponge, cleaning pad, soap, wash cloth, towel, cleaning rag, and air freshener; or an electronic device selected from: cell phone, communication device, wireless electronic device, portable music player, radio, shower radio, and clock; or a kitchen utensil selected from: hand tool, screw driver, pliers, tape measure, flash light, yard tool, rake, shovel, thermometer, picture frame, soap dish, towel rack, tube clamp, and hook; or a product packaging selected from: stationary supply, notebook, writing utensil, clip board, and toy; or a container selected from: bottle, bottle cap, bottle topper, tube, pill case, and carrying case.
